(19) United States
(12) Patent Application Publication
(10) Pub. No.: US 2015/0016657 A1
(43) Pub. Date: Jan. 15, 2015

(54) VIBRATING DIAPHRAGM AND SOUNDER USING THE SAME

(71) Applicants: Wei Song, Shenzhen (CN); Chunmei She, Shenzhen (CN)

(72) Inventors: Wei Song, Shenzhen (CN); Chunmei She, Shenzhen (CN)

(73) Assignees: AAC MICROTECH (CHANGZHOU) CO., LTD., Changzhou (CN); AAC ACOUSTIC TECHNOLOGIES (SHENZHEN) CO., LTD., Shenzhen (CN)

(21) Appl. No.: 14/162,918

(22) Filed: Jan. 24, 2014

(30) Foreign Application Priority Data
Jul. 10, 2013 (CN) 201320410163.8

(51) Int. Cl. H04R 7/06; H04R 7/16

(52) U.S. Cl. CPC H04R 7/06; H04R 7/16
USPC 381/398; 181/167

(57) ABSTRACT

A diaphragm and a sounder using the same are disclosed in the present disclosure. The diaphragm includes a suspension portion and a dome assembled with the suspension portion. The dome includes a polyethylene terephthalate (PET) layer, a middle layer and an adhesive layer, with the middle layer sandwiched between the PET layer and the adhesive layer. The middle layer is formed with a first through hole for adjusting the deformation amount of the diaphragm. The present disclosure can improve the flatness of the dome and prevent deformation of the dome after the vibration.

### FIELD OF THE INVENTION

The present disclosure generally relates to the art of sound generators, and more particularly, to a sounder having a diaphragm driven by a voice coil.

### DESCRIPTION OF RELATED ARTS

As being propelled by the increasingly heightened requirements on mobile phones in the market, the mobile phones trends to be designed with low profile and better sound quality. For meeting this trend or requirement, acoustic components used in the mobile phones should also be designed to have small sizes and high sound quality.

The diaphragm is known as a core element of an acoustic component such as a speaker. During vibration of the diaphragm, the shape of the dome of the diaphragm may unbalance the vibration of the diaphragm, and further, the dome may distort after the vibration of the diaphragm. Especially for a diaphragm having a long and narrow shape, these problems will much more outstanding. To solve the problems mentioned, various improved domes have been developed actively in the art.

Accordingly, the present disclosure provides a sounder with an improved diaphragm to overcome the aforesaid problems.

### BRIEF DESCRIPTION OF THE DRAWINGS

FIG. 1 is an exploded isometric view of a sounder according to an embodiment of the present disclosure; and

FIG. 2 is a schematic view illustrating a dome of a diaphragm of the sounder in FIG. 1.

### DETAILED DESCRIPTION OF THE INVENTION

Hereinbelow, the present disclosure will be described in detail with reference to the attached drawings and embodiments thereof.

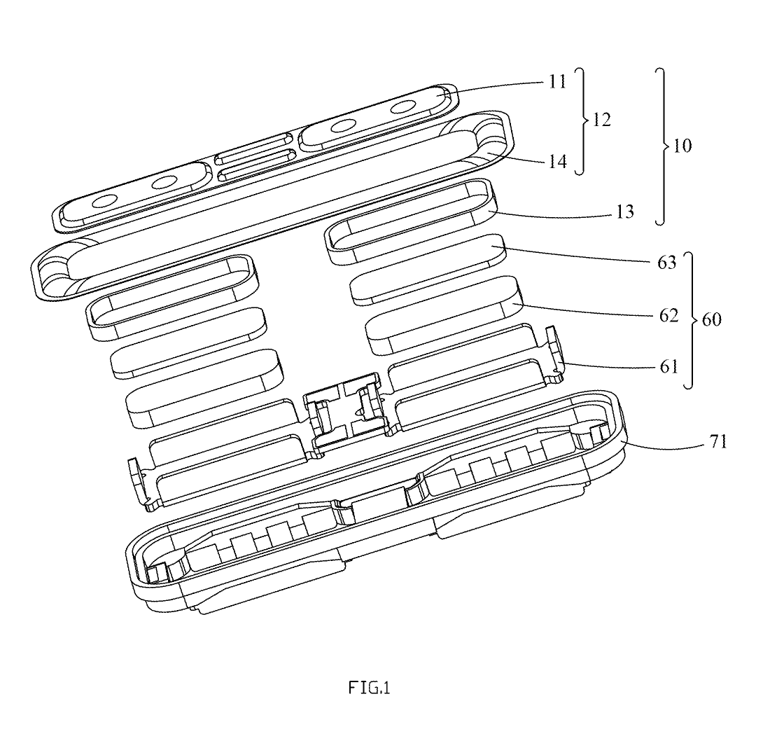

As shown in FIG. 1, the sounder 100 of this embodiment is mainly used in portable consumer electronic products such as mobile phones to provide the user with audio output. The sounder 100 comprises a frame 71, a magnetic circuit system 60 received in the frame 71, and a vibration system 10 fixed on the frame 71 or the magnetic circuit system 60.

The magnetic circuit system 60 comprises a magnetic bowl 61 received in the frame 71, magnets 62 positioned on the magnetic bowl 61 and pole plates 63 attached on surfaces of the magnets 62. The magnetic bowl 62 may be bowl-shaped, or be a plate, or be other shape.

The vibration system 10 comprises a diaphragm 12 and a voice coil 13 fixed below the diaphragm 12.

The diaphragm 12 comprises a suspension portion 14 and a dome 11 assembled with the suspension portion 14. While assembled, the dome 11 is substantially surrounded by the suspension portion 14, and the dome 11 substantially locates at the center part of the diaphragm 12. In this embodiment, the dome 11 is separated from and assembled with the suspension portion 14, i.e., the diaphragm is a two-piece configuration. In fact, in other alternative embodiment, the dome may be integrated with the suspension portion, i.e., the diaphragm is a one-piece configuration.

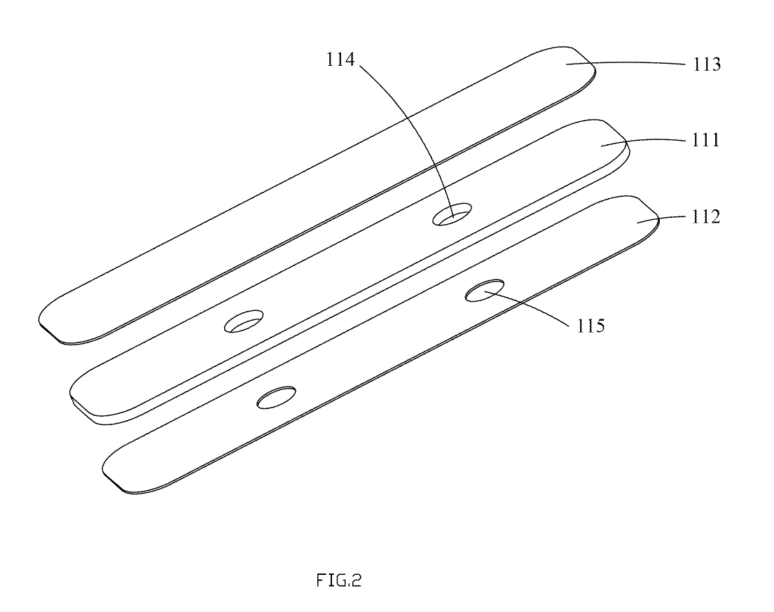

As shown in FIG. 2, the dome 11 comprises a polyethylene terephthalate (PET) layer 113, a middle layer 111 and an adhesive layer 112, with the middle layer 111 being sandwiched between the PET layer 113 and the adhesive layer 112. The PET layer 113 is adhered to the middle layer 111 by means of glue, adhesive, soldering, or the like. In this embodiment, the adhesive layer 112 is adhesive tape. The middle layer 111 is adhered to the suspension portion 14 of the diaphragm 12 by the adhesive layer 112. The middle layer 111 is formed with a first through hole 114 for adjusting a deformation amount of the dome 11. In this embodiment, the amount of the first through hole 114 is configured to be two. In fact, the amount of the first through holes may be various according to actual requirements.

Optionally, the adhesive layer 112 is formed with a second through hole 115 aligning with the first through hole 114.

Optionally, the dome 11 is long and narrow, and the first through holes are arranged along a major axis of the dome 11.

Optionally, the middle layer 111 is made of wood material.

Optionally, the dome 111 is adhered to the suspension portion 14 by the adhesive layer 112.

For a long and narrow dome of the prior art, the diaphragm tends to deform in the major axis direction when it vibrates to generate sound, which will badly affect the flatness of the dome. By contrast with the prior art, in the present disclosure, the through hole for adjusting the deformation amount is formed in the middle layer of the dome, so the deformation of the diaphragm as a whole can get improved and the flatness of the diaphragm can be adjusted.

In the embodiment recited above, the dome is provided with a three-layer configuration, i.e., a middle layer sandwiched between a PET layer and an adhesive layer. So called middle layer is sandwiched between two layers, not means the middle layer of the diaphragm. In addition, this three-layer configuration may be applied on the whole diaphragm.

What described above are only exemplary embodiments of the present disclosure, and the scope of the present disclosure is not limited to what described above. Rather, any equivalent modifications or changes made by those of ordinary skill in the art according to the contents of the present disclosure shall all fall within the scope of the present disclosure.

What is claimed is:

1. A diaphragm for a sounder, comprising:
a suspension portion, and
a dome assembled with the suspension portion, the dome comprising:
a polyethylene terephthalate (PET) layer,
an adhesive layer; and
a middle layer sandwiched between the PET layer and the adhesive layer, the middle layer formed with a first through hole for adjusting deformation amount of the diaphragm.

2. The diaphragm of claim 1, wherein the PET layer is adhered to the middle layer by means of the adhesive material.

3. The diaphragm of claim 1, wherein the adhesive layer is formed with a second through hole aligning with the first through hole of the middle layer.

4. The diaphragm of claim 1, wherein the dome is long and narrow, and the middle layer is provided with a plurality of first through holes arranged along a major axis direction of the dome.

5. The diaphragm of claim 1, wherein the middle layer is made of wood material.

6. The diaphragm of claim 5, wherein the dome is adhered to the suspension portion by the adhesive layer.

7. A sounder, comprising:
a frame, and
a vibration system supported by the frame, the vibration system comprising a diaphragm, and a voice coil fixed below the diaphragm, the diaphragm comprising:
a suspension portion, and
a dome comprising a polyethylene terephthalate (PET) layer, a middle layer and an adhesive layer, with the middle layer sandwiched between the PET layer and the adhesive layer, wherein the middle layer is formed with a first through hole for adjusting deformation amount of the diaphragm.

8. A compound diaphragm for a sound generator, comprising:
a first layer;
a second layer;
a third layer having a side attached to the first layer, and another side attached to the second layer, wherein
the third layer forms a plurality of first through holes for adjusting the deformation amount of the diaphragm.

9. The compound diaphragm as described in claim 8, wherein the first layer is a polyethylene terephthalate layer, and the second layer is an adhesive layer.

10. The compound diaphragm as described in claim 9, wherein the third layer is a wood layer.

11. The compound diaphragm as described in claim 8, wherein the second layer forms a plurality of second through holes aligning with the first through holes.
